(19) United States
(12) Patent Application Publication
(10) Pub. No.: US 2017/0116333 A1
(43) Pub. Date: Apr. 27, 2017

(54) AUTOMATIC ASSOCIATION OF CONTENT FROM SOURCES

(71) Applicant: Hewlett Packard Enterprise Development LP, Houston, TX (US)

(72) Inventors: Joshua Hailpern, Sunnyvale, CA (US); Murilo Juchem, Vancouver, WA (US); William J. Allen, Corvallis, OR (US)

(21) Appl. No.: 15/317,147

(22) PCT Filed: Jun. 30, 2014
(86) PCT No.: PCT/US2014/044940

§ 371 Date: Dec. 8, 2016

(51) Int. Cl. G06F 17/30

(52) U.S. Cl. CPC G06F 17/30864; G06F 17/30905

(57) ABSTRACT

Example implementations relate to automatic association of content from sources. For example, a computing device may include a processor. The processor may identify a content item being related to a particular source of a plurality of sources accessible by the computing device, where each source of the plurality of sources is independent from other sources in the plurality of sources. The content item is sent to a server managing relationships between content from the plurality of sources, where the server automatically associates the content item with other relevant content items from the plurality of sources. Information identifying the other relevant content items is received from the server. The content item is displayed with the other relevant content items in response to receiving the information.

### BACKGROUND

Many entities utilize several independent systems for various operations. For example, a company may use a third-party email system for email services, a third-party web page system for web page services, a database management system for managing databases used by the company, and the like. Content from these disparate systems may be stored, accessed, and managed independently (e.g., by the third-party providing the service).

### BRIEF DESCRIPTION OF THE DRAWINGS

Some examples of the present application are described with respect to the following figures:

FIG. 1 is a block diagram of example computing devices in a system for automatically associating content from sources;

FIG. 2 is a flowchart illustrating an example method of displaying associated content from sources;

FIG. 3 is a flowchart illustrating an example method of automatically associating content from sources;

FIG. 4 is an interface diagram of an example user interface to display associated content from sources;

FIG. 5 is an interface diagram of an example user interface to create and assign a new task associated with content from sources; and

FIG. 6 is an interface diagram of an example user interface to create a progress report using content from sources.

### DETAILED DESCRIPTION

As described above, many entities may utilize several independent systems for various operations. The content from these disparate sources may be stored in independent silos used by each of the sources. While the content may be accessed from each source, it may be difficult to determine whether content from one source is related to content in another source.

To more efficiently access related content from different sources, a content management server may be used to associate the content from the different sources such that when a particular content item is accessed and/or displayed, any additional content items relevant to that particular content item may be provided. The content management server may be used in any suitable context, such as in a company setting, for technical worker task processing (e.g., as a team), for a team of healthcare professionals moving a patient through a clinic for a procedure (e.g., surgery), and the like. Providing related content from disparate sources may decrease redundancy, may increases visibility, and may allow for better project tracking and expectation management. For example, a user may access an email from an email source (e.g., a third-party email service) through the user's computing device using a client application associated with the content management server. When the email is accessed, the content management server may determine whether there are any additional content items from other sources (or from the same email source) that is or may be related to the email and may provide any relevant content to the user through the client application. For example, if the content of the email includes words, phrases, or sentences that may appear to be related to a particular project, the content management server may access other content related to the project and may provide that content to the client application.

A source may be any individual computing system controlling, managing, and/or providing data, such as content, services, features, and the like. Examples of sources include communication sources (e.g., email source, chat source, etc.), meeting sources (e.g., calendar source, meeting room management source, etc.), team management sources (e.g., lightweight directory access protocol (LDAP) source, task management source, etc.), knowledge management sources (e.g., a dictionary source, an encyclopedia source, a question and answer (Q&A) list serve source, etc.), deliverable management sources, financial management sources (e.g., budgetary tracking source, etc.), database management sources, cloud storage sources, any other suitable sources (e.g., legal sources, consulting sources, etc.), and the like.

A source may be operated and managed by the entity utilizing the content management server or by a third party (e.g., third-party email service). In some examples, a source may be accessed using credentials associated with a user account of the source. For example, a user's email may be accessed from an email source after the credentials (e.g., username and/or password) associated with the user's email account are provided. A source may be accessed by the content management server in any suitable manner. In some examples, the content management server may have access to a user's credentials for user accounts associated with different sources. For example, a user may provide the credentials for various accounts to the client application, and the accounts may be accessed by the content management server using the credentials provided. In some examples, the content management server may not have access to a user's credentials, and the client application may prompt the user to log into the user's accounts through the client application on the user's computing device. Once the user is logged into the accounts, the client application may pull content from the sources and create associations between content. The associations may be sent from the client application to the content management server such that the associations may be stored without providing the content management server with direct access to the user's source accounts.

The content management server may access and associate content items from various sources in any suitable manner. A content item may be any individual data item, file, and the like that may be stored in a database associated with its respective source (e.g., a single email, a meeting notice, a dictionary entry, a text document, an audio file, a video file, etc.). The content management server may automatically index the content items using any suitable association management engine. For example, the content items may be indexed based on keywords and/or tags, user accounts associated with the content items, temporality (e.g., to focus on more recent clusters of content items), and the like. In some examples, the automatic association of content items may be based on semantic or temporal clustering and/or named-entity recognition, which may be used to create relationships and topics between content items. The relationship data may be used to dynamically draw clusters for content items. In some examples, the relationship data may be stored by the content management server in separate buckets for each user. In some examples, content items may also be associated and/or disassociated with other content items manually. For example, a user may manually group a particular email with other content items related to a particular project, or a user may notice that a particular email has been automatically associated with other content items related to a project and may choose to manually disassociate the email from the other content items. In some examples, when an association between content items is determined, the user may be provided with an option to accept and/or decline the suggested association. In some examples, the association of content items may be performed by leveraging user-level knowledge and phrases and/or by leveraging entity-level knowledge and phrases. For example, digitized voice records may be converted with speech-to-text algorithms and fed into semantic, word-matching, or any other context-determining algorithms to associate the digitized voice records with other content items.

In some examples, the content management server and the client application may provide additional services related to content item. For example, task and workflow management for personal and/or cross-team tasks may be provided such that a task may be presented with any relevant content items (e.g., related emails, documents, etc.). Deadlines for a users deliverables (or for other users' deliverables) may be managed and/or tracked. In some examples, managers may be able to see tasks assigned to subordinates, which may provide easier management of team members' expectations and may reduce variance and risks of over-running deadlines. Other examples of additional services that may be provided include progress reporting, performing employee reviews, budgeting, billing (e.g., can estimate and/or track minutes to bill a client, who to bill, time spent performing certain tasks, etc.), interfacing with a bug list (e.g., for software developers) or other non-corporate structures (e.g., publishing houses) to draw on external references and context, filtering of content, and the like. In some examples, tasks may be created automatically based on the content within content items. For example, if an email appears to be associated with a potential task for a user, the task may be automatically created and associated with the email and any other relevant content items. In some examples, a content item may be used to create another content item, and the content item created may be automatically associated with the original content item. For example, a task may be used to create a meeting notice for a meeting, and the task may be automatically associated with the meeting notice. In some examples, tasks may be ranked in any suitable manner. In some examples, a task may be associated with multiple content items from multiple other clusters of contextual similarity. For example, if the progress of a task is presented by a particular organization to another organization within a company, the task could be associated with a personal development goal (e.g., gain more presentation experience) and/or may be associated with a team goal of sharing task progress with the other organization.

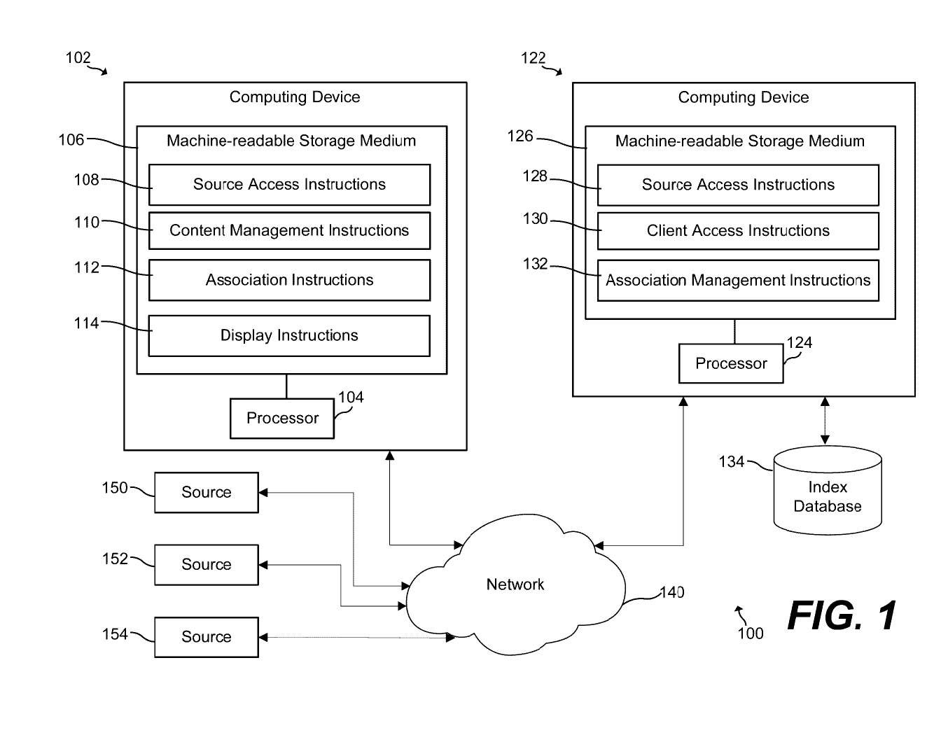

Referring now to the figures, FIG. 1 is a block diagram of example computing devices 102 and 122 in a system 100 for automatically associating content from sources (e.g., source 150, 152, and/or 154). Computing device 102, computing device 122, and sources 150, 152, and 154 may be in communication with each other directly or over network 140, which may be any suitable network. In various examples, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks. In some examples, computing device 102 may be a client device of a user and may be used to access and display content items from one or more sources, such as sources 150, 152, and 154. In some examples, computing device 122 may be a content management server or may be associated with a content management server that may associate, index, and access content items from one or more sources, such as sources 150, 152, and 154. In some examples, computing device 102 and computing device 122 may be the same device. Sources 150, 152, and 154 may each be an individual computing system controlling, managing, and/or providing data, such as content, services, features, and the like.

Computing device 102 may be, for example, a web-based server, a local area network server, a cloud-based server, a notebook computer, a desktop computer, an all-in-one system, a tablet computing device, a mobile phone, an electronic book reader, or any other electronic device suitable for displaying associated content items from sources, such as sources 150, 152, and 154. Computing device 102 may include a processor 104 and a machine-readable storage medium 106. Computing device 102 may be in communication with one or more additional computing devices, such as computing device 122. Computing device 102 may be a client device of a user and may be used to access and display content items from one or more sources, such as sources 150, 152, and 154.

Processor 104 may be a central processing unit (CPU), a semiconductor-based microprocessor, and/or other hardware devices suitable for retrieval and execution of instructions stored in machine-readable storage medium 106. Processor 104 may fetch, decode, and execute instructions 108, 110, 112, and 114 to control a process of displaying associated content items from sources, such as sources 150, 152, and 154. As an alternative or in addition to retrieving and executing instructions, processor 104 may include at least one electronic circuit that includes electronic components for performing the functionality of instructions 108, 110, 112, 114, or a combination thereof.

Machine-readable storage medium 106 may be any electronic, magnetic, optical, or other physical storage device that contains or stores executable instructions. Thus, machine-readable storage medium 106 may be, for example, Random Access Memory (RAM), an Electrically Erasable Programmable Read-Only Memory (EEPROM), a storage device, an optical disc, and the like. In some examples, machine-readable storage medium 106 may be a non-transitory storage medium, where the term “non-transitory” does not encompass transitory propagating signals. As described in detail below, machine-readable storage medium 106 may be encoded with a series of processor executable instructions 108, 110, 112, and 114 for identifying a content item being related to a particular source of a plurality of sources (e.g., sources 150, 152, and 154), sending the content item to a content management server (e.g., computing device 122) that manages relationships between content from the plurality of sources, receiving, from the content management server, information identifying other relevant content items automatically associated with the content item, and displaying the content item with the other relevant content items in response to receiving the information.

Source access instructions 108 may manage and control access to one or more sources associated with a user (e.g., sources 150, 152, and 154). For example, source access instructions 108 may manage and control any credentials associated with user accounts for various sources that a user may access and may facilitate access to the various sources.

Content management instructions 110 may manage and control content items. For example, content management instructions 110 may identify a content item related to a particular source, may send a content item (or a portion of a content item, such as keywords) to computing device 122 such that computing device 122 may index the content item, may allow content items to be accessed, modified, stored, and/or deleted, may provide any additional services and/or features associated with content items (e.g., progress reports), and the like.

Association instructions 112 may manage and control associations between content items. For example, association instructions may receive information identifying associations between content items, may facilitate manual associations and disassociations, may automatically associate content items, may maintain a local index of associations between content items, and the like,

Display instructions 114 may manage and control the display of content items with other relevant content items. For example, if an email is being displayed, display instructions 114 may manage and control the display of other content items related to the email.

Computing device 122 may be, for example, a web-based server, a local area network server, a cloud-based server, a notebook computer, a desktop computer, an all-in-one system, a tablet computing device, a mobile phone, an electronic book reader, or any other electronic device suitable for automatically associating content items from sources, such as sources 150, 152, and 154. Computing device 122 may include a processor 124 and a machine-readable storage medium 126. Computing device 122 may be in communication with one or more additional computing devices, such as computing device 102. Computing device 122 may be a content management server or may be associated with a content management server that may associate, index, and access content items from one or more sources, such as sources 150, 152, and 154.

Processor 124 may be a central processing unit (CPU), a semiconductor-based microprocessor, and/or other hardware devices suitable for retrieval and execution of instructions stored in machine-readable storage medium 126. Processor 124 may fetch, decode, and execute instructions 128, 130, and 132 to control a process of automatically associating content items from sources, such as sources 150, 152, and 154. As an alternative or in addition to retrieving and executing instructions, processor 124 may include at least one electronic circuit that includes electronic components for performing the functionality of instructions 128, 130, 132, or a combination thereof.

Machine-readable storage medium 126 may be any electronic, magnetic, optical, or other physical storage device that contains or stores executable instructions. Thus, machine-readable storage medium 126 may be, for example, Random Access Memory (RAM), an Electrically Erasable Programmable Read-Only Memory (EEPROM), a storage device, an optical disc, and the like. In some examples, machine-readable storage medium 126 may be a non-transitory storage medium, where the term “non-transitory” does not encompass transitory propagating signals. As described in detail below, machine-readable storage medium 126 may be encoded with a series of processor executable instructions 128, 130, and 132 for receiving a content item being related to a particular source of a plurality of sources (e.g., sources 150, 152, and 154) accessible by a computing device (e.g., computing device 102), identifying other content items from the plurality of sources where the other content items are relevant to the content item and identified based on a semantic cluster associated with the other content items, automatically associating the content item with the other content items, and providing information identifying the other content items to the computing device (e.g., computing device 102).

Source access instructions 128 may manage and control access to sources. For example, source access instructions 128 may access a source to obtain content items and any additional information related to a content item.

Client access instructions 130 may manage and control access to a client application on a computing device of a user, such as computing device 102. For example, client access instructions 130 may access a client application to obtain content items and any additional information related to a content item, send information relating to associations between content items, and the like.

Association management instructions 132 may manage and control the indexing and associations between content items. For example, association management instructions 132 may identify or determine content items that may be related to each other (e.g., based on semantic clustering), create or modify associations between content items, store associations for content items in index database 134, and the like.

Index database 134 may be a database in any suitable format (e.g., a relational database) that may store any information relating to how a content item is related to one or more other content items. In some examples, index database may store tables identifying semantic clusters for content items. In some examples, the data in index database 134 may be stored on a per-user basis.

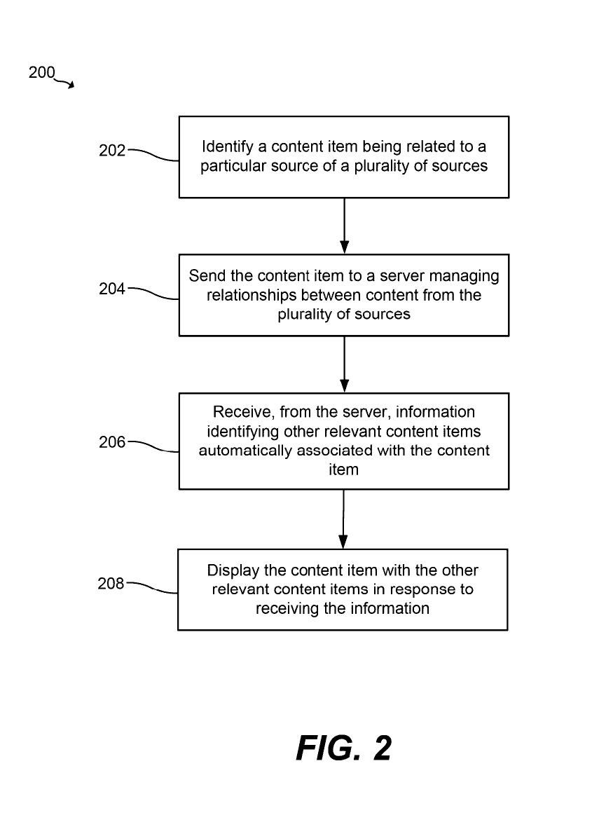

FIG. 2 is a flowchart illustrating an example method 200 of displaying associated content from sources. Method 200 may be implemented using computing device 102 of FIG. 1.

Method 200 includes, at 202, identifying a content item being related to a particular source of a plurality of sources (e.g., sources 150, 152, and 154). As described above, each source in the plurality of sources may be independent from other sources in the plurality of sources.

Method 200 also includes, at 204, sending the content item to a server (e.g., computing device 122 of FIG. 1) managing relationships between content from the plurality of sources. As described above, the server may use the content item or information about the content item to automatically associate the content item with other relevant content items from the plurality of sources.

Method 200 also includes, at 206, receiving, from the server, information identifying other relevant content items automatically associated with the content item. For example, the information may be the relevant content items themselves, information indicating the location of the content items, and the like.

Method 200 also includes, at 208, displaying the content item with the other relevant content items in response to receiving the information. The content item and the other relevant content items may be displayed and/or modified through a user interface for the client application associated with the content management server.

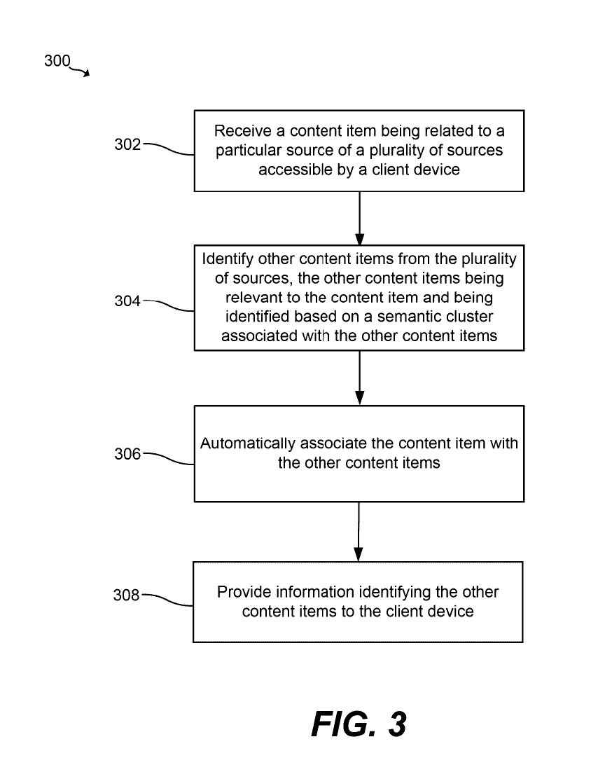

FIG. 3 is a flowchart illustrating an example method 300 of automatically associating content from sources. Method 300 may be implemented using computing device 122 of FIG. 1.

Method 300 includes, at 302, receiving a content item being related to a particular source of a plurality of sources (e.g., sources 150, 152, and 154 of FIG. 1) accessible by a client device (e.g., computing device 102 of FIG. 1). As described above, each source in the plurality of sources may be independent from other sources in the plurality of sources.

Method 300 also includes, at 304, identifying other content items from the plurality of sources, where the other content items are relevant to the content item and are identified based on a semantic cluster associated with the other content items. For example, index database 134 may be accessed to determine whether there are any other content items that may be relevant to the content item received.

Method 300 also includes, at 306, automatically associating the content item with the other content items. For example, the content item may be associated with the other relevant content items through the index database 134. The automatic association may occur in any manner (e.g., synchronously or asynchronously).

Method 300 also includes, at 308, providing information identifying the other content items to the client device. The client device may then use the information to display the other content items with the original content item, provide additional features and/or services, and the like.

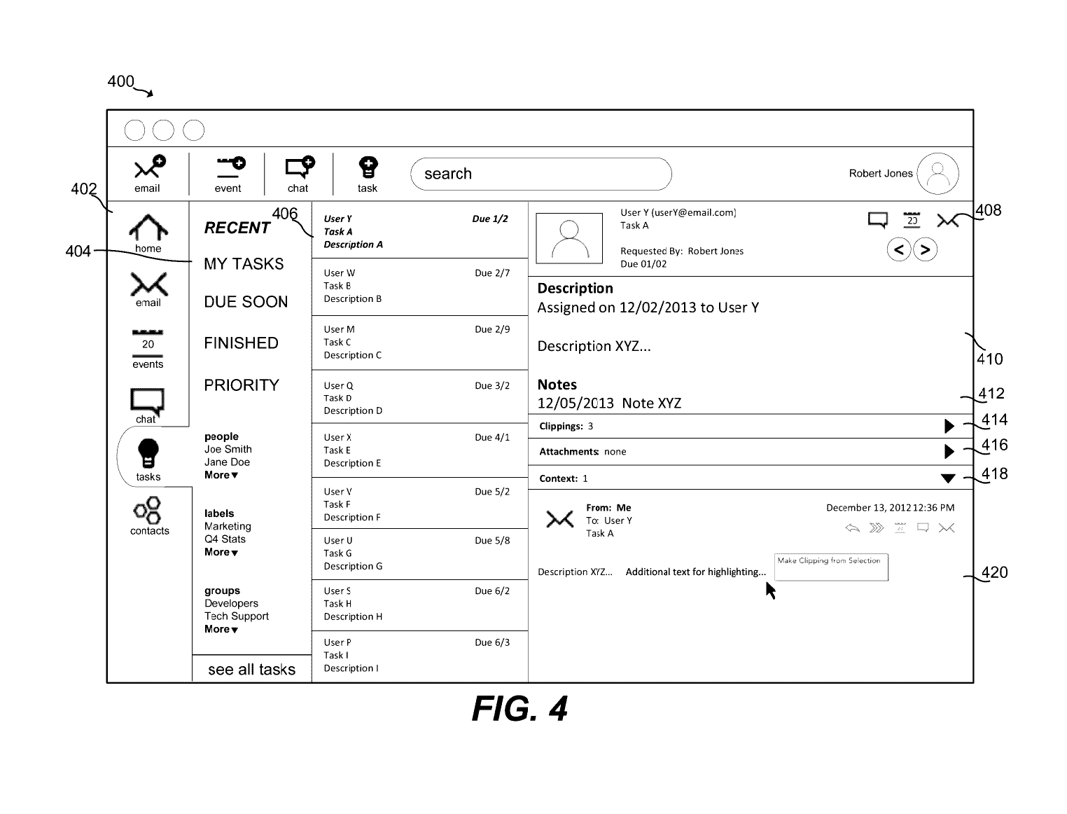

FIG. 4 is an interface diagram of an example user interface 400 to display associated content from sources. The user interface 400 may be displayed on a client computing device (e.g., computing device 102 of FIG. 1) and may be part of a client application associated with a content management server (e.g., computing device 122 of FIG. 1). The user interface 400 may be associated with content items for a particular user (e.g., user Robert Jones). The user interface 400 may allow the user to add and/or create various content items (e.g., email, events, chat, tasks, etc.), interact with content items (e.g., modify or delete content items), and search for various content items associated with the user's account.

Panel 402 of user interface 400 displays a home button and content item buttons associated with types of content items that may be displayed (e.g., email, events, chat, tasks, contacts). Each of the content item buttons in panel 402 may allow the corresponding content item to be displayed. For example, if the email content item button is selected, the user's email may be displayed. For each email displayed, any other relevant content items may also be displayed with the email. As shown in FIG. 4, the task content item button in panel 402 has been selected, and a list 406 of tasks for the user are displayed. In some examples, a content item in the list 406 may be visually emphasized (e.g., bolded, highlighted, etc.) if the content item is assigned to the user. Task A has been selected from the list 406 of tasks and is displayed in user interface 400 along with other relevant content items (e.g., notes, clippings 414, attachments 416, context 418, etc.).

Panel 404 displays various filters that may be used to organize and view certain content items (e.g., tasks). For example, since the tasks content item button is selected in panel 402, panel 404 displays various filters that may be applied to the tasks associated with the user (e.g., recent tasks, my tasks, task that are due soon, finished tasks, priority tasks, etc.). Additionally, tasks may be filtered based on other criteria, such as the people assigned to the task, labels associated with the task, groups of people associated with the task, and the like. In some examples, a particular content item may appear in more than one context. For example, a colleague may be shown to be associated with both Project A and Project B.

Section 410 displays a description of Task A and the users to whom Task A may be assigned. Section 410 also shows any notes that may be associated with Task A. In some examples, there may be an option to delete various content items associated with a particular content item. For example, if Note XYZ was automatically associated with Task A, the user may use the button 412 to disassociate the note from Task A. Additionally, buttons 408 may be used to create a content item that is a chat message, event, or email from Task A such that the created content item may be automatically associated with Task A.

Any number and type of related content items may be displayed with Task A. In the example of FIG. 4, Task A is associated with clippings 414, attachments 416, and context 418, and as such, these related content items are displayed with Task A. Clippings 414 may include any content items that are portions of other content items. For example, the portion of text 420 from a content item may be highlighted by the user to make an additional clipping. Attachments 416 may include any content item documents that may be related to Task A (e.g., a text document, an image, a file, a screenshot, etc.). Context 418 may include any content items with content that is relevant to Task A (e.g., emails, chats, etc.).

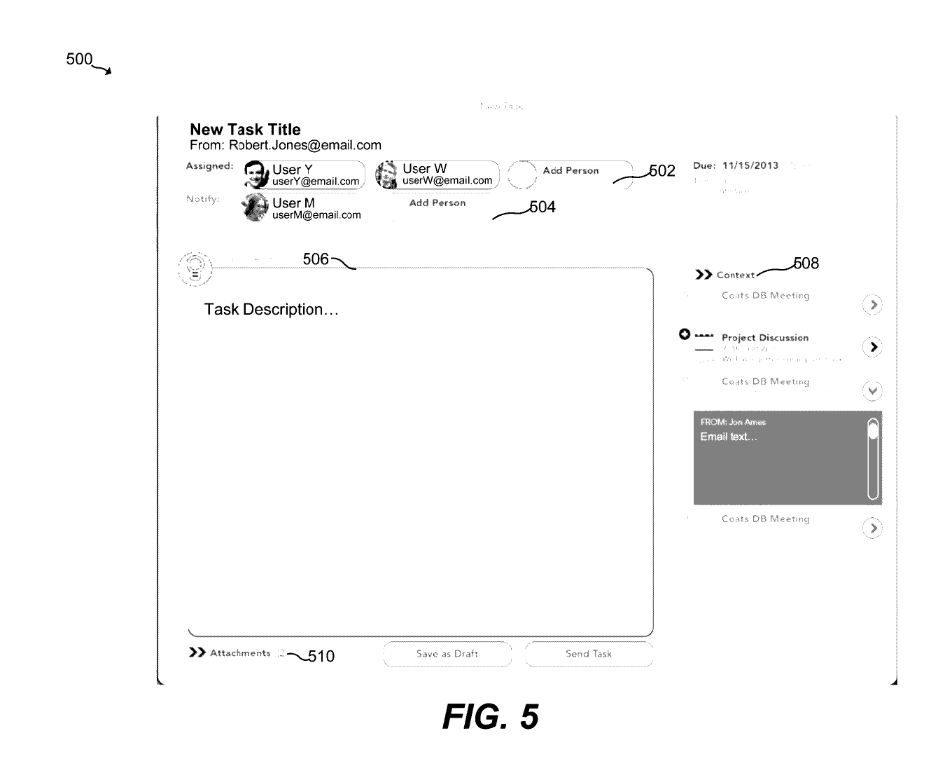

FIG. 5 is an interface diagram of an example user interface 500 to create and assign a new task associated with content from sources. User interface 500 includes button 502 to add a person to the list of users that are assigned to the new task and button 504 to add a person to the list of user that are to be notified of the new task.

Section 506 allows the user to add a description of the new task being created. Section 508 displays any relevant content items that are to be associated with the new task being created. The relevant content items may be added automatically and/or manually. Additionally, the new task may be automatically and/or manually associated with attachments 510.

In some examples, when a task is created manually, the task can be manually tagged with key terms to improve semantic clusters. In some examples, a task may tagged to indicate a particular filter (e.g., priority, deadlines, etc.).

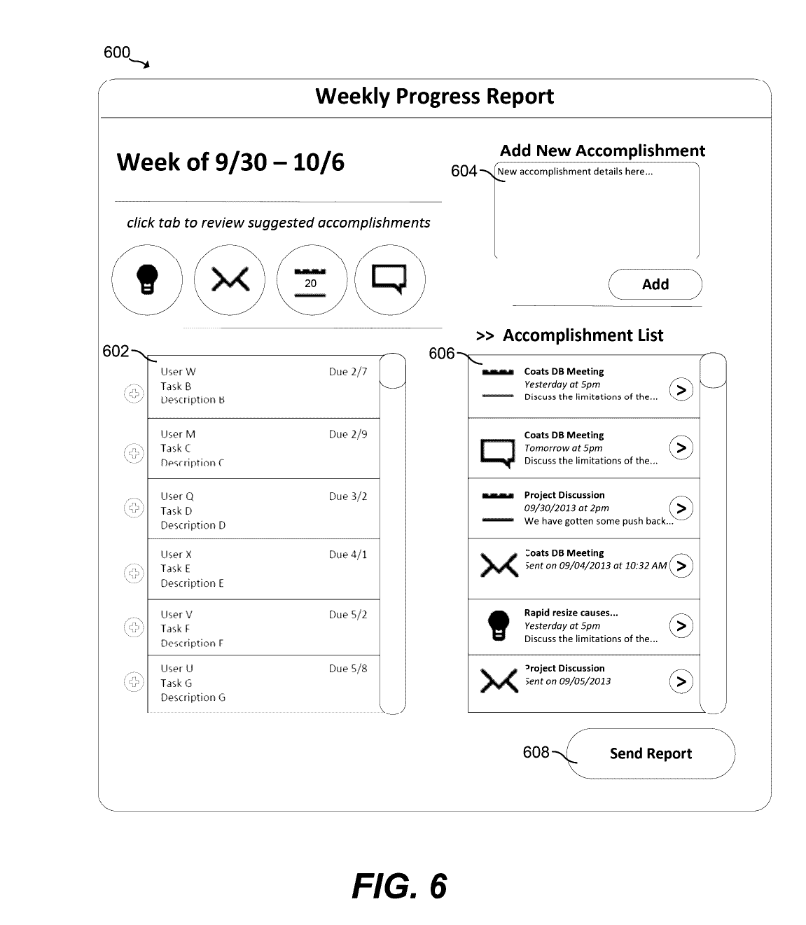

FIG. 6 is an interface diagram of an example user interface 600 to create a progress report using content from sources. Section 602 of user interface 600 displays a list of tasks that may be used in the creation of the progress report. For example, a user may select a particular task to add to the progress report, and the progress report may show the progress of that particular task, including any measures of activity for a particular task (e.g., creation rates of content associated with a task). Additionally, accomplishment list 606 may display content items that may provide additional information about the progress of certain tasks. New accomplishments may be added to this list using section 604. Once the user has completed the selection of content items for use in the progress report, the user may select button 608 to send the progress report.

Examples provided herein (e.g., methods) may be implemented in hardware, software, or a combination of both. Example systems may include a controller/processor and memory resources for executing instructions stored in a tangible non-transitory medium (e.g., volatile memory, non-volatile memory, and/or machine-readable media). Non-transitory machine-readable media can be tangible and have machine-readable instructions stored thereon that are executable by a processor to implement examples according to the present disclosure.

An example system can include and/or receive a tangible non-transitory machine-readable medium storing a set of machine-readable instructions (e.g., software). As used herein, the controller/processor can include one or a plurality of processors such as in a parallel processing system. The memory can include memory addressable by the processor for execution of machine-readable instructions. The machine-readable medium can include volatile and/or non-volatile memory such as a random access memory (“RAM”), magnetic memory such as a hard disk, floppy disk, and/or tape memory, a solid state drive (“SSD”), flash memory, phase change memory, and so on.

What is claimed is:

1. A computing device comprising:
a processor to:
identify a content item being related to a particular source of a plurality of sources accessible by the computing device, each source of the plurality of sources being independent from other sources in the plurality of sources;
send the content item to a server managing relationships between content from the plurality of sources, the server automatically associating the content item with other relevant content items from the plurality of sources;
receive, from the server, information identifying the other relevant content items automatically associated with the content item: and
display the content item with the other relevant content items in response to receiving the information.

2. The computing device of claim 1, wherein the content item is an email, a document, a web page, an event notice, a task, or a chat message.

3. The computing device of claim 1, wherein the plurality of sources includes at least one of a communication source, a meeting source, a team management source, a knowledge management source, a deliverable management source, a database source, and a financial management source.

4. The computing device of claim 1, wherein the processor is further to:
receive a user input identifying a particular content item from the other relevant content items; and
disassociate the particular content item from the content item.

5. The computing device of claim 1, wherein the processor is further to generate a progress report based on the content item and the other relevant content items.

6. The computing device of claim 1, wherein the content item is automatically associated with the other relevant content items based on a semantic cluster of the other relevant content items.

7. A method comprising;
receiving, by a computing device, a content item being related to a particular source of a plurality of sources accessible by a client device, each source of the plurality of sources being independent from other sources in the plurality of sources;
identifying, by the computing device, other content items from the plurality of sources, the other content items being relevant to the content item and being identified based on a semantic cluster associated with the other content items;
automatically associating, by the computing device, the content item with the other content items; and
providing, by the computing device, information identifying the other content items to the client device.

8. The method of claim 7, wherein the content item is an email, a document, a web page, an event notice, a task, or a chat message.

9. The method of claim 7, wherein the plurality of sources includes at least one of a communication source, a meeting source, a team management source, a knowledge management source, a deliverable management source, a database source, and a financial management source.

10. The method of claim 7, wherein automatically associating the content item with the other content items includes creating a semantic relationship between the content item and the other content items based on content of the content item.

11. A non-transitory machine-readable storage medium storing instructions that, if executed by at least one processor of a computing device, cause the computing device to:
receive a content item being related to a particular source of a plurality of sources accessible by the computing device, each source of the plurality of sources being independent from other sources in the plurality of sources;
send the content item to a server managing relationships between content from the plurality of sources, the server automatically associating the content item with other relevant content items from the plurality of sources based on a semantic cluster of the other relevant content items;
obtain, from the server, information identifying the other relevant content items automatically associated with the content item; and
provide the content item with the other relevant content items in response to receiving the information.

12. The non-transitory machine-readable storage medium of claim 11, wherein the content item is an email, a document, a web page, an event notice, a task, or a chat message.

13. The non-transitory machine-readable storage medium of claim 11, wherein the plurality of sources includes at least one of a communication source, a meeting source, a team management source, a knowledge management source, a deliverable management source, a database source, and a financial management source.

14. The non-transitory machine-readable storage medium of claim 11, wherein the instructions, if executed by the at least one processor, further cause the computing device to:
receive a user input identifying a particular content item from the other relevant content items; and
disassociate the particular content item from the content item.

15. The non-transitory machine-readable storage medium of claim 11, wherein the instructions, if executed by the at least one processor, further cause the computing device to generate a progress report based on the content item and the other relevant content items.
